(19) United States
(12) Patent Application Publication
(10) Pub. No.: US 2023/0191665 A1
(43) Pub. Date: Jun. 22, 2023

(54) METHOD OF MANUFACTURING A FORMING TOOL

(71) Applicant: Lear Corporation, Southfield, MI (US)

(72) Inventors: Alex Taylor, Southfield, MI (US); Asad Ali, Southfield, MI (US); Ian Dixon, Southfield, MI (US); Ray A. Romero, Southfield, MI (US); Reza Fard-Aghaie, Southfield, MI (US); Sangramsihn Salunkhe, Southfield, MI (US); Amit Budhale, Southfield, MI (US); Rajesh Jadhav, Southfield, MI (US); Irina Cojocariu, Southfield, MI (US); Vikrant Kajale, Southfield, MI (US); Paul Wilkinson, Southfield, MI (US)

(73) Assignee: Lear Corporation, Southfield, MI (US)

(21) Appl. No.: 17/555,922

(22) Filed: Dec. 20, 2021

(51) Int. Cl. B29C 33/38; B33Y 80/00; B33Y 10/00; B29C 33/00

(52) U.S. Cl. CPC B29C 33/3842; B29C 33/0038; B33Y 10/00; B33Y 80/00; B29L 2031/757

(57) ABSTRACT

A method of manufacturing a forming tool. The forming tool may include at least one die having a perimeter wall and a profile panel. At least a portion of the die may be manufactured using an additive manufacturing process. For instance, the profile panel may be manufactured using an additive manufacturing process or the profile panel and additional portions of the die, such as the perimeter wall, may be manufactured using an additive manufacturing process.

### TECHNICAL FIELD

The present invention relates to a method of manufacturing a forming tool in which at least a portion of the forming tool is manufactured using an additive manufacturing process.

### BACKGROUND

An additive manufacturing process is disclosed in U.S. Pat. No. 10,173,264.

### SUMMARY

In at least one embodiment, a method of manufacturing a forming tool is provided. The method may include making a first die and making a second die. Making the first die may include manufacturing a first profile panel with an additive manufacturing process, providing a first base that has a first perimeter wall, positioning the first profile panel on the first perimeter wall, and securing the first profile panel to the first perimeter wall. Making the second die may include manufacturing a second profile panel with an additive manufacturing process, providing a second base that has a second perimeter wall, positioning the second profile panel on the second perimeter wall, and securing the second profile panel to the second perimeter wall.

In at least one embodiment, a method of manufacturing a forming tool is provided. The method may include manufacturing first and second die portions of a first die with an additive manufacturing process. The first die portion of the first die may define a first profile panel portion of a first profile panel, a first baseplate portion of a first baseplate, and a first perimeter wall portion of a first perimeter wall. The first profile panel portion of the first profile panel, the first baseplate portion of the first baseplate, and the first perimeter wall portion of the first perimeter wall may cooperate to define a first cavity portion of the first die portion. The second die portion of the first die may define a second profile panel portion of the first profile panel, a second baseplate portion of the first baseplate, and a second perimeter wall portion of the first perimeter wall. The second profile panel portion, the second baseplate portion, and the second perimeter wall portion may cooperate to define a second cavity portion of the second die portion. The first and second die portions may be assembled together such that the first profile panel portion extends from the second profile panel portion, the first baseplate portion extends from the second baseplate portion, and the first perimeter wall portion extends from the second perimeter wall portion.

### BRIEF DESCRIPTION OF THE DRAWINGS

FIG. 1 is a perspective view of an example of a forming tool having a first die and a second die.

FIG. 2 is a perspective view of the first die.

FIG. 3 is an exploded view of the first die.

FIG. 4 is a perspective view of the second die.

FIG. 5 is an exploded view of the second die.

FIG. 6 is a section view of the forming tool along section line 6-6.

FIG. 7 is a perspective view of another example of a forming tool having a first die and a second die.

FIG. 8 is a section view along section line 8-8.

FIG. 9 is a section view along section line 9-9 in the opposite direction from section line 8-8.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

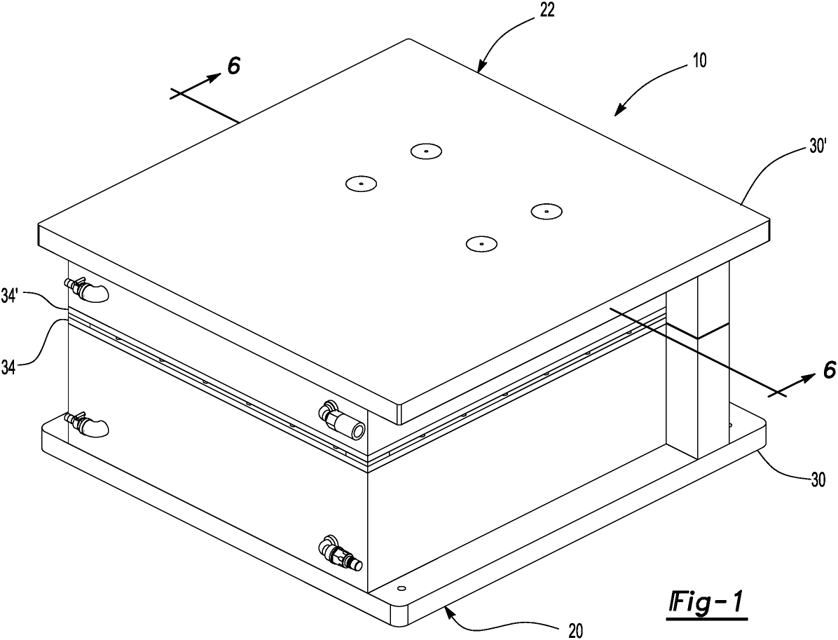

Referring to FIG. 1, an example of a forming tool 10 is shown. The forming tool 10 may be configured to form material that is received inside of the forming tool 10 into a desired shape. For instance, the forming tool 10 may be used to mold, cast, or otherwise shape a liquid or solid material that is received inside of the forming tool 10. The forming tool 10 will primarily be discussed in the context of a mold or die set that may be used to form a polymeric material, such as a polyurethane foam, into a cushion, such as a cushion for a vehicle seat.

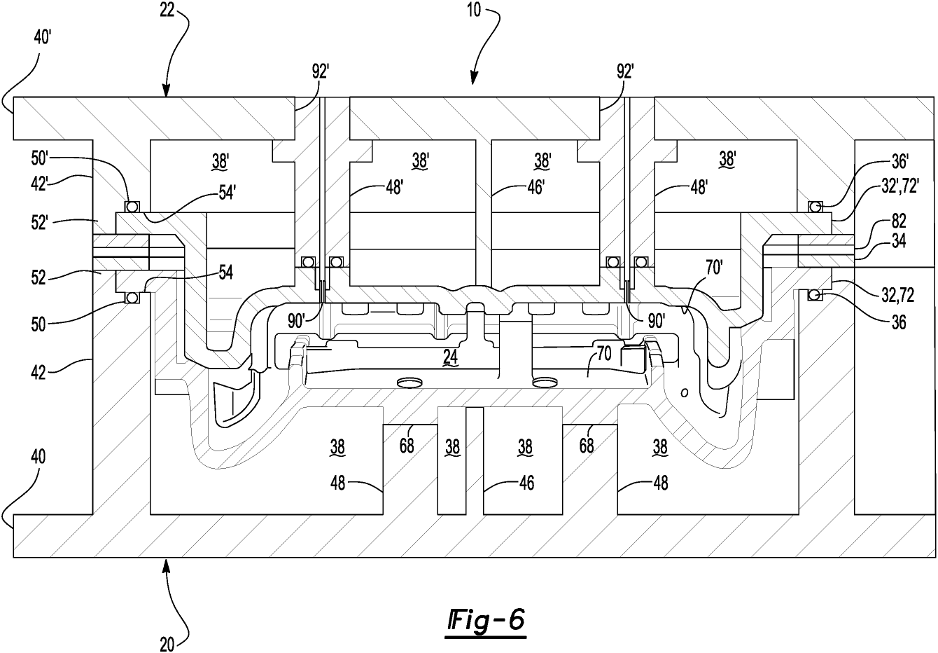

The forming tool 10 may include a die set that may include a plurality of dies, such as a first die 20 and a second die 22. The first die 20 and the second die 22 may be receivable in a press or other actuation device that may move at least one of the first die 20 and the second die 22 between an open position and a closed position in a manner known by those skilled in the art. In the open position, the first die 20 and the second die 22 may be separated or moved apart to facilitate access to a forming cavity 24, which is best shown in FIG. 6, that is defined by the first die 20 and the second die 22 when the forming tool 10 is closed. In the closed position, the first die 20 and the second die 22 may contact or engage each other to help enclose the forming cavity 24 and form the material that is received in the forming cavity 24. In FIG. 6, a single forming cavity 24 is shown; however, it is contemplated that the first die 20 and the second die 22 may cooperate to define multiple forming cavities 24 and that the forming cavities 24 may be configured to make the same or different part designs.

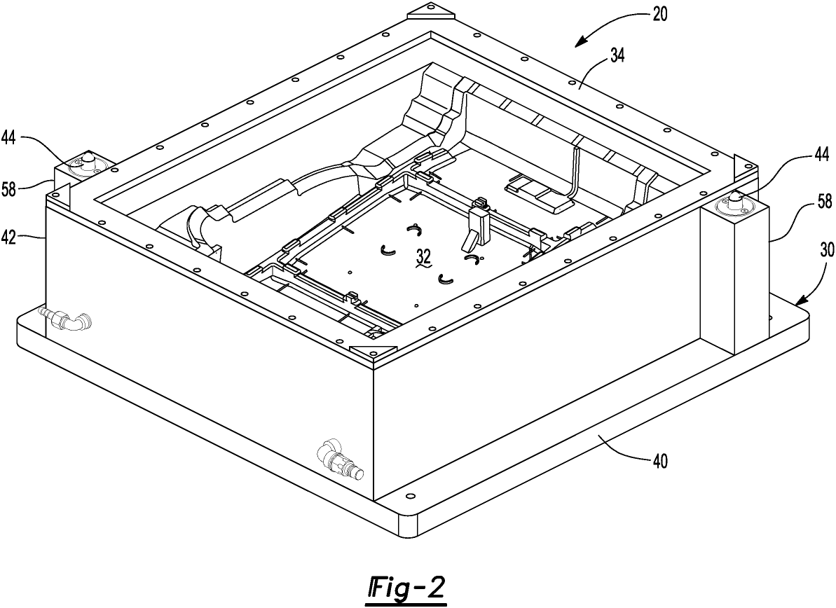

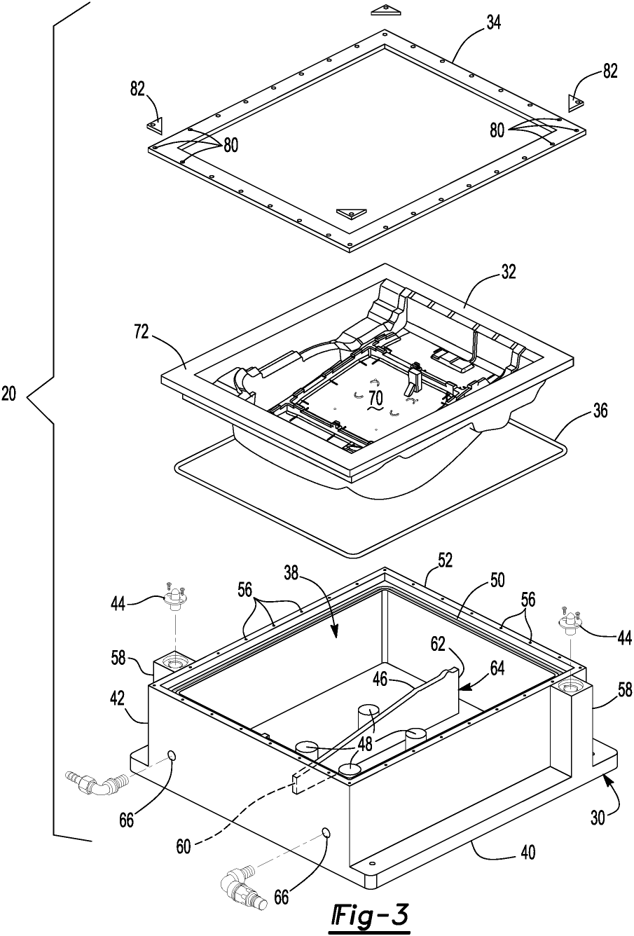

Referring to FIGS. 1-3, an example of a first die 20 is shown. In FIG. 1, the first die 20 is depicted as being a lower die that is disposed beneath the second die 22 and supports the second die 22 when the forming tool 10 is closed; however, it is contemplated that the positioning of the first die 20 and the second die 22 may be reversed or that the first die 20 and the second die 22 may be positioned in other orientations. In at least one configuration and as is best shown with reference to FIGS. 2 and 3, the first die 20 may include a first base 30, a first profile panel 32, a first mounting panel 34, and a first seal 36. In addition, the first die 20 may define a first cavity 38.

The first base 30 may support the first profile panel 32 and may be configured to be mounted to the press. In at least one configuration, the first base 30 may include a first baseplate 40, a first perimeter wall 42, and one or more locator features 44. Optionally, the first base 30 may include one or more baffles 46, one or more support columns 48, or both. One or more components of the first base 30, such as the first baseplate 40, the first perimeter wall 42, one or more locator features 44, one or more baffles 46, and one or more support columns 48, may be provided as separate components or may be integrally formed. The first base 30 and its components may be made of any suitable material or materials, such as metal, a polymeric material, or combinations thereof.

The first baseplate 40 may be a generally flat plate from which other features of the first base 30 may extend. The first baseplate 40 may be mountable to the press. For instance, the first baseplate 40 may include one or more mounting holes that may receive a fastener that may facilitate mounting of the first baseplate 40 to the press.

The first perimeter wall 42 may extend from the first baseplate 40 toward the first profile panel 32 and the first mounting panel 34. The first perimeter wall 42 may support the first profile panel 32. The first perimeter wall 42 may enclose or define a perimeter of the first cavity 38 and may include one or more individual walls. In the configuration shown, the first perimeter wall 42 is provided with four individual walls that are arranged in a generally rectangular configuration. In at least one configuration, the first perimeter wall 42 may include a first seal groove 50, a first ring wall 52, or both.

Referring primarily to FIG. 6, the first seal groove 50 may be configured as a recess or indentation that may partially receive the first seal 36. For instance, the first seal groove 50 may be a recess that is provided in an end surface 54 of the first perimeter wall 42 that extends toward the first baseplate 40. The first seal groove 50 may extend continuously around the first cavity 38. It is also contemplated that the first seal groove 50 may be omitted.

The first ring wall 52, if provided, may extend further away from the first baseplate 40 than the first seal groove 50, the end surface 54, or both. For instance, the first ring wall 52 may protrude past the end surface 54 of the first perimeter wall 42. In at least one configuration, the first ring wall 52 may extend continuously around the first cavity 38 and the first seal 36. In addition, the first ring wall 52 may optionally extend around a portion of the first profile panel 32. The first ring wall 52 may facilitate fastening of the first mounting panel 34 to the first perimeter wall 42. For instance, the first ring wall 52 may include a plurality of mounting features 56 that may facilitate mounting of the first mounting panel 34 to the first ring wall 52. The mounting features 56 may have any suitable configuration. For instance, a mounting feature 56 may have a male configuration, female configuration, or combinations thereof. In the configuration shown, the mounting features 56 are configured as holes, such as threaded holes, that may each receive a corresponding fastener that may secure the first mounting panel 34 to the first ring wall 52. For clarity, the fasteners are not shown in FIG. 3.

Referring to FIGS. 2 and 3, one or more locator features 44 may be provided with the first base 30 to facilitate alignment of the first die 20 and the second die 22. A locator feature 44 may have any suitable configuration. For instance, a locator feature 44 may have a male configuration, a female configuration, or combinations thereof. In the configuration shown, two locator features 44 are illustrated that are provided with a male configuration. The locator features 44 may be provided in any suitable location. In the configuration shown, each locator feature 44 is disposed proximate an end of a column 58 that may extend from the first baseplate 40 and the first perimeter wall 42. The column 58 and the locator feature 44 may be disposed outside of the first cavity 38. For instance, the column 58 and the locator feature 44 may be positioned along a side of the first perimeter wall 42 that faces away from and is disposed opposite the first cavity 38.

Referring to FIG. 3, one or more baffles 46 may be disposed in the first cavity 38. A baffle 46 may extend from the first baseplate 40 toward or to the first profile panel 32. A baffle 46 may help route a fluid through the first cavity 38. For instance, the baffle 46 may have a first end 60 and a second end 62. The first end 60 may contact or engage the first perimeter wall 42. The second end 62 may be disposed opposite the first end 60 and may be spaced apart from the first perimeter wall 42 to provide a gap 64 through which the fluid may flow. In the configuration shown, the baffle 46 is generally positioned between a pair of ports 66 that may be provided with the first perimeter wall 42. In the configuration shown, fluid may enter the first cavity 38 through one port, flow toward the second end 62 of the baffle 46, pass through the gap 64 and flow around the second end 62 between the second end 62 and the first perimeter wall 42, flow to the other port 66, and exit the first cavity 38. It is to be understood that ports may be provided in different locations and that one or more baffles may route fluid along a different flow path than is shown. Each port 66 may receive or may be fluidly connected to a fitting, which in turn may be fluidly connected to a heat transfer circuit that may facilitate heat transfer in a manner known by those skilled in the art.

Referring to FIG. 6, the baffle 46 may extend to the first profile panel 32 to support the first profile panel 32. It is contemplated that a baffle 46 may be removable and replaceable to accommodate different profile panel configurations or that different profile panel configurations may have standardized contact pads or contact points that may permit profile panels to be interchanged without replacing or modifying the baffle 46.

Referring to FIGS. 3 and 6, one or more support columns 48 may be provided in the first cavity 38 to support the first profile panel 32. A support column 48 may extend from the first baseplate 40 to the back side of the first profile panel 32. A support column 48 may be spaced apart from the first perimeter wall 42, a baffle 46, or combinations thereof. It is contemplated that a support column 48 may be removable and replaceable to accommodate different profile panel configurations or that different profile panel configurations may have standardized contact pads or contact points that may permit profile panels to be interchanged without replacing or modifying the support columns 48. In FIG. 6, the contact pads 68 are shown protruding from the back side of the first profile panel 32.

Referring primarily to FIGS. 3 and 6, the first profile panel 32 may extend from the first mounting panel 34 to the first seal 36. In at least one configuration, the first profile panel 32 may have a forming surface 70 and a rim 72.

The forming surface 70 may be contoured or profiled to provide a desired shape to the material that is formed in the forming cavity 24. As such, the forming surface 70 may partially define the forming cavity 24 and may contact the material that is formed in the forming cavity 24.

The rim 72 may define a perimeter of the first profile panel 32. The rim 72 may generally extend around or encircle the forming surface 70 and may facilitate mounting of the first profile panel 32 to the first base 30. In at least one configuration, the rim 72 may be generally planar and may be supported by the first perimeter wall 42. For instance, the rim 72 may rest upon the first seal 36 and may engage a portion of the first perimeter wall 42, such as the end surface 54. The rim 72 may be encircled by the first ring wall 52.

The first profile panel 32 may be made by an additive manufacturing process. An additive manufacturing process is a process in which a component or product is created by building a component or product in layers, such as by three dimensional (3D) printing. An additive manufacturing process may be the opposite of subtractive manufacturing process in which an object is created by removing material from a solid piece of material to provide a desired shape. An additive manufacturing process may build layers using any suitable material or materials, such as a polymeric material, metal, ceramic, or the like. For instance, a profile panel may be made of a material that includes or is reinforced with fibers such as glass fiber, carbon fiber or the like. A profile panel that is used to manufacture a foam part may be made of any suitable material that can provide the desired geometry, has sufficient structural stiffness to withstand manufacturing pressures, and that has sufficient thermal conductivity.

Additive manufacturing may be accomplished in many ways. As one example, a nozzle may be used to lay successive layers of material on top of each other until the final product is complete. In such a configuration, a successive layer may be laid when an underlying layer can provide sufficient support, such as when the underlying layer is sufficiently hardened or solidified. As another example, a bed may be filled with powder and portions of the powder may be melted and allowed to bond and solidify to form a solid part layer by layer. The powder may be melted in any suitable manner, such as with lasers or electron beams. The loose powder that is not melted may be removed from or may fall away from the final solid part. As another example, layers of powder may be adhered using a polymer, then the layers may be placed in a furnace to melt the polymer and sinter the powder into a part.

Referring to FIGS. 2, 3, and 6, the first mounting panel 34 may facilitate mounting of the first profile panel 32 to the first base 30. For instance, the first mounting panel 34 may secure the first profile panel 32 to the first perimeter wall 42 to inhibit movement of the first mounting panel 34 with respect to the first base 30. The first mounting panel 34 may have any suitable configuration. In the configuration shown, the first mounting panel 34 has a generally rectangular ring shape that may contact or engage the rim 72 and the first perimeter wall 42. For example, the first mounting panel 34 may overlap the first ring wall 52 and the rim 72.

As is best shown in FIG. 3, the first mounting panel 34 may include a plurality of mounting features 80 that may facilitate mounting of the first mounting panel 34 to the first perimeter wall 42. For instance, a mounting feature 80 may be configured as a through hole that may be aligned with a corresponding mounting feature 56 of the first ring wall 52 and receive a fastener, such as a screw that may secure the first mounting panel 34. For clarity, the fasteners are not shown in FIG. 3.

The first mounting panel 34 may optionally include one or more contact pads 82 that may contact the second die 22. In the configuration shown, four contact pads 82 are provided and are located at corners of the first mounting panel 34; however, it is contemplated that a different number of contact pads 82 may be provided and that the contact pads 82 may be provided in other locations. The contact pads 82 may be integrally formed or provided as separate components. It is also contemplated that the contact pads 82 may be provided with the second die 22.

Referring to FIGS. 3 and 6, the first seal 36 may extend between the first base 30 and the first profile panel 32. For example, the first seal 36 may extend from the first perimeter wall 42 to the rim 72 of the first profile panel 32. The first seal 36 may be partially received in the first seal groove 50 as previously discussed.

Referring to FIGS. 3 and 6, the first cavity 38 may be defined by the first baseplate 40, the first perimeter wall 42, and the first profile panel 32. For example, in the perspective shown the first cavity 38 may extend in a generally vertical direction from the first baseplate 40 to the back side of the first profile panel 32 that faces away toward the first baseplate 40 and the perimeter of the first cavity 38 may be bounded by the first perimeter wall 42. The first cavity 38 may receive one or more items that may help control the temperature of the first profile panel 32. For instance, the first cavity 38 may receive a fluid that may facilitate the transfer of thermal energy between the first profile panel 32 and the fluid (e.g., the fluid may heat the first profile panel 32, cool the first profile panel 32, or both) . Alternatively or in addition, the first cavity 38 may receive a heat transfer device, such as heat exchanger, a heat lamp, or heating element.

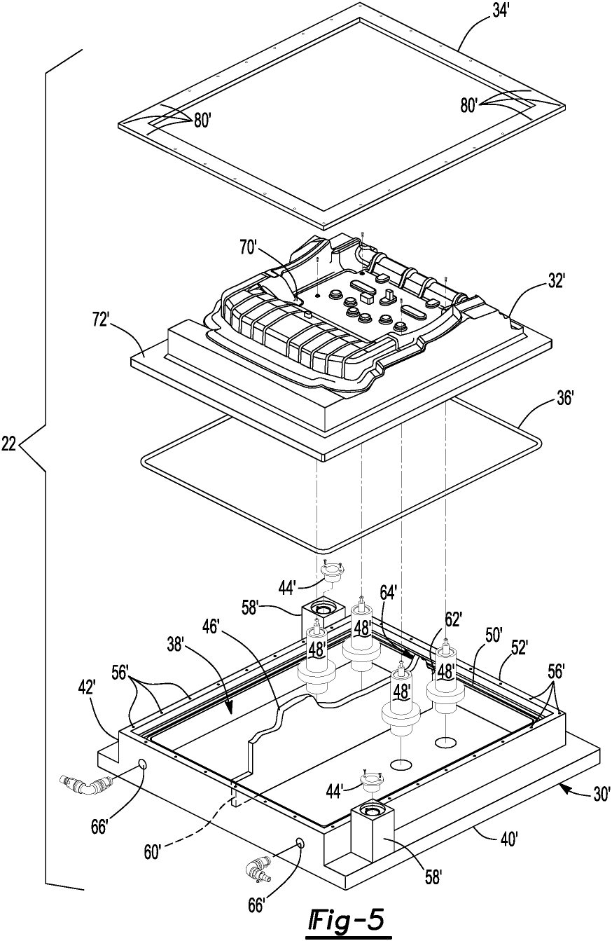

Referring to FIGS. 1, 4, and 5, an example of a second die 22 is shown. In FIG. 1, the second die 22 is depicted as being an upper die that is disposed above the first die 20 when the forming tool 10 is closed; however, it is contemplated that the positioning of the first die 20 and the second die 22 may be reversed or the first die 20 and the second die 22 may be positioned in other orientations as previously discussed. In at least one configuration and as is best shown with reference to FIG. 5, the second die 22 may include a second base 30′, a second profile panel 32′, a second mounting panel 34′, and a second seal 36′. In addition, the second die 22 may define a second cavity 38′.

The second base 30′ may support the second profile panel 32′ and may be configured to be mounted to the press. In at least one configuration, the second base 30′ may include a second baseplate 40′, a second perimeter wall 42′, and one or more locator features 44′. Optionally, the second base 30′ may include one or more baffles 46′, one or more ventilation tubes 48′, or both. One or more components of the second base 30′, such as the second baseplate 40′, the second perimeter wall 42′, one or more locator features 44′, and one or more baffles 46′, may be provided as separate components or may be integrally formed. The second base 30′ and its components may be made of any suitable material or materials, such as metal, polymeric material, or combinations thereof.

The second baseplate 40′ may be a generally flat plate from which other features of the second base 30′ may extend. The second baseplate 40′ may be mountable to the press. For instance, the second baseplate 40′ may include one or more mounting holes that may receive a fastener that may facilitate mounting of the second baseplate 40′ to the press.

The second perimeter wall 42′ may extend from the second baseplate 40′ toward the second profile panel 32′ and the second mounting panel 34′. The second perimeter wall 42′ may support the second profile panel 32′. The second perimeter wall 42′ may enclose or define a perimeter of the second cavity 38′ and may include one or more individual walls. In the configuration shown, the second perimeter wall 42′ is provided with four individual walls that are arranged in a generally rectangular configuration. In at least one configuration, the second perimeter wall 42′ may include a second seal groove 50′, a second ring wall 52′, or both.

Referring primarily to FIG. 6, the second seal groove 50′ may be configured as a recess or indentation that may partially receive the second seal 36′. For instance, the second seal groove 50′ may be a recess that is provided in an end surface 54′ of the second perimeter wall 42′ that extends toward the second baseplate 40′. The second seal groove 50′ may extend continuously around the second cavity 38′. It is also contemplated that the second seal groove 50′ may be omitted.

The second ring wall 52′, if provided, may extend further away from the second baseplate 40′ than the second seal groove 50′, the end surface 54′, or both. For instance, the second ring wall 52′ may protrude past the end surface 54′ of the second perimeter wall 42′. In at least one configuration, the second ring wall 52′ may extend continuously around the second cavity 38′ and the second seal 36′. In addition, the second ring wall 52′ may optionally extend around a portion of the second profile panel 32′. The second ring wall 52′ may facilitate fastening of the second mounting panel 34′ to the second perimeter wall 42′. For instance, the second ring wall 52′ may include a plurality of mounting features 56′ that may facilitate mounting of the second mounting panel 34′ to the second ring wall 52′. The mounting features 56′ may have any suitable configuration. For instance, a mounting feature 56′ may have a male configuration, female configuration, or combinations thereof. In the configuration shown, the mounting features 56′ are configured as holes, such as threaded holes, that may each receive a corresponding fastener that may secure the second mounting panel 34′ to the second ring wall 52′. For clarity, the fasteners are not shown in FIG. 5.

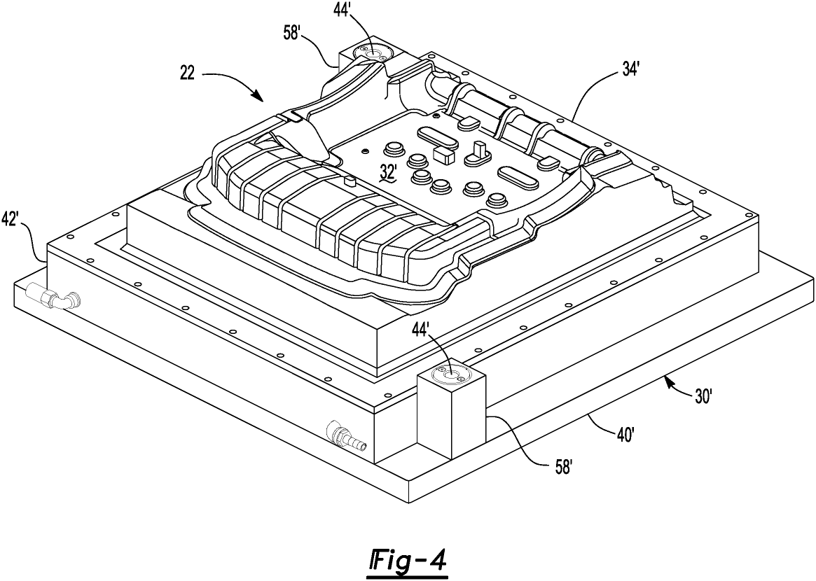

Referring to FIGS. 4 and 5, one or more locator features 44′ may be provided with the second base 30′ to facilitate alignment of the second die 22 and the first die 20. A locator feature 44′ may have any suitable configuration that is compatible with the locator feature 44 of the first die 20. For instance, a locator feature 44′ may have a male configuration, a female configuration, or combinations thereof. In the configuration shown, two locator features 44′ are illustrated that are provided with a female configuration. A locator feature 44′ may mate with a corresponding locator feature 44 on the first die 20 when the die set is closed. The locator features 44′ may be provided in any suitable location. In the configuration shown, each locator feature 44′ is disposed proximate an end of a column 58′ that may extend from the second baseplate 40′ and the second perimeter wall 42′. The column 58′ and the locator feature 44′ may be disposed outside of the second cavity 38′. For instance, the column 58′ and the locator feature 44′ may be positioned along a side of the second perimeter wall 42′ that faces away from and is disposed opposite the second cavity 38′.

Referring to FIG. 5, one or more baffles 46′ may be disposed in the second cavity 38′. A baffle 46′ may extend from the second baseplate 40′ toward or to the second profile panel 32′. A baffle 46′ may help route a fluid through the second cavity 38′. For instance, the baffle 46′ may have a first end 60′ and a second end 62′. The first end 60′ may contact or engage the second perimeter wall 42′. The second end 62′ may be disposed opposite the first end 60′ and may be spaced apart from the second perimeter wall 42′ to provide a gap 64′ through which the fluid may flow. In the configuration shown, the baffle 46′ is generally positioned between a pair of ports 66′ that may be provided with the second perimeter wall 42′. In the configuration shown, fluid may enter the second cavity 38′ through one port, flow toward the second end 62′ of the baffle 46′, pass through the gap 64′ and flow around the second end 62′ between the second end 62′ and the second perimeter wall 42′, flow to the other port 66′, and exit the second cavity 38′. It is to be understood that ports may be provided in different locations and that one or more baffles may route fluid along a different flow path than is shown. Each port 66′ may receive or may be fluidly connected to a fitting, which in turn may be fluidly connected to a heat transfer circuit that may facilitate heat transfer in a manner known by those skilled in the art.

Referring to FIG. 6, the baffle 46′ may extend to the second profile panel 32′ to support the second profile panel 32′. It is contemplated that a baffle 46′ may be removable and replaceable to accommodate different profile panel configurations or that different profile panel configurations may have standardized contact pads or contact points that may permit profile panels to be interchanged without replacing or modifying the baffle 46′.

Referring to FIGS. 5 and 6, one or more ventilation tubes 48′ may be provided in the second cavity 38′ to ventilate gas from the forming cavity 24. In FIG. 5, four ventilation tubes 48′ are shown with a pair of ventilation tubes 48′ disposed on opposing sides of the baffle 46′; however, a different number or different arrangement of ventilation tubes 48′ may be provided. As is best shown in FIG. 6, a ventilation tube 48′ may define an internal passage that may extend between a vent hole 90′ in the second profile panel 32′ and an exhaust hole 92′ that may be provided in the second baseplate 40′. A ventilation tube 48′ may also support the second profile panel 32′. A ventilation tube 48′ may extend from the second baseplate 40′ to the back side of the second profile panel 32′. In at least one configuration, the ventilation tube 48′ may be fastened to the second profile panel 32′. For instance, a fastener that has a through hole may extend through the vent hole 90′ into the internal passage of the ventilation tube 48′. A ventilation tube 48′ may be spaced apart from the second perimeter wall 42′, a baffle 46′, or combinations thereof. It is contemplated that a ventilation tube 48′ may be removable and replaceable to accommodate different profile panel configurations or that different profile panel configurations may have standardized contact pads or contact points that may permit profile panels to be interchanged without replacing or modifying the ventilation tube 48′. It is also contemplated that the ventilation tubes 48′ may be omitted and that the forming cavity 24 may be vented in a different manner, such as with a parting line vent.

Referring primarily to FIGS. 5 and 6, the second profile panel 32′ may extend from the second mounting panel 34′ to the second seal 36′. In at least one configuration, the second profile panel 32′ may have a forming surface 70′ and a rim 72′.

The forming surface 70′ may be contoured or profiled to provide a desired shape to the material that is formed in the forming cavity 24. As such, the forming surface 70′ may partially define the forming cavity 24 and may contact the material that is formed in the forming cavity 24.

The rim 72′ may define a perimeter of the second profile panel 32′. The rim 72′ may generally extend around or encircle the forming surface 70′ and may facilitate mounting of the second profile panel 32′ to the second base 30′. In at least one configuration, the rim 72′ may be generally planar and may be supported by the second perimeter wall 42′. For instance, the rim 72′ may rest upon the second seal 36′ and may engage a portion of the second perimeter wall 42′, such as the end surface 54′. The rim 72′ may be encircled by the second ring wall 52′. The second profile panel 32′ may be made by an additive manufacturing process as previously discussed with respect to the first profile panel 32.

Referring to FIGS. 4-6, second mounting panel 34′ may facilitate mounting of the second profile panel 32′ to the second base 30′. For instance, the second mounting panel 34′ may secure the second profile panel 32′ to the second perimeter wall 42′ to inhibit movement of the second mounting panel 34′ with respect to the second base 30′. The second mounting panel 34′ may have any suitable configuration. In the configuration shown, the second mounting panel 34′ has a generally rectangular ring shape that may contact or engage the rim 72′ and the second perimeter wall 42′. For example, the second mounting panel 34′ may overlap the second ring wall 52′ and the rim 72′.

As is best shown in FIG. 5, the second mounting panel 34′ may include a plurality of mounting features 80′ that may facilitate mounting of the second mounting panel 34′ to the second perimeter wall 42′. For instance, a mounting feature 80′ may be configured as a through hole that may be aligned with a corresponding mounting feature 56′ of the second ring wall 52′ and receive a fastener, such as a screw that may secure the second mounting panel 34′. For clarity, the fasteners are not shown in FIG. 5.

Referring to FIGS. 5 and 6, the second seal 36′ may extend between the second base 30′ and the second profile panel 32′. For example, the second seal 36′ may extend from the second perimeter wall 42′ to the rim 72′ of the second profile panel 32′. The second seal 36′ may be partially received in the second seal groove 50′ as previously discussed.

Referring to FIGS. 5 and 6, the second cavity 38′ may be defined by the second baseplate 40′, the second perimeter wall 42′, and the second profile panel 32′. For example, in the perspective shown the second cavity 38′ may extend in a generally vertical direction from the second baseplate 40′ to the back side of the second profile panel 32′ that faces away toward the second baseplate 40′ and the perimeter of the second cavity 38′ may be bounded by the second perimeter wall 42′. The second cavity 38′ may receive one or more items that may help control the temperature of the second profile panel 32′. For instance, the second cavity 38′ may receive a fluid that may facilitate the transfer of thermal energy between the second profile panel 32′ and the fluid (e.g., the fluid may heat the second profile panel 32′, cool the second profile panel 32′, or both). Alternatively or in addition, the second cavity 38′ may receive a heat transfer device, such as heat exchanger, a heat lamp, or heating element.

A method of making the tool 10 will now be described. As an overview, components of the first die 20 and the second die 22 may be fabricated and then assembled to provide the first die 20 and the second die 22. Since the first die 20 and the second die 22 have similar components the associated method steps are similar.

First, components of the first die 20 may be fabricated. The first profile panel 32 may be manufactured using an additive manufacturing process as previously discussed while other components of the first die 20 may or may not be manufactured using an additive manufacturing process. Components of the first base 30 may be assembled if they are not integrally formed.

Next, the first profile panel 32 may be positioned on the first perimeter wall 42 with the first seal 36 sandwiched in between. For instance, the first seal 36 may be installed on the first base 30, such as by positioning the first seal 36 in the first seal groove 50, before installing the first profile panel 32 (i.e., before positioning the first profile panel 32 on the first perimeter wall 42). Alternatively, the first seal 36 may be installed on the first profile panel 32, such as by providing the first seal 36 on the back side of the rim 72, before installing the first profile panel 32 (i.e., before positioning the first profile panel 32 on the first perimeter wall 42). The first mounting panel 34 may engage with the first profile panel 32, the first perimeter wall 42, or both. For example, the first mounting panel 34 may be positioned to contact or engage the rim 72 of the first profile panel 32 and the first ring wall 52 of the first perimeter wall 42.

Next, the first profile panel 32 may be secured to the first perimeter wall 42 after positioning the first profile panel 32 on the first perimeter wall 42. Securing the first profile panel 32 may include securing or fastening the first profile panel 32 with one or more fasteners such as screws as previously discussed.

The second die 22 may be manufactured and assembled in a similar manner as the first die 20.

First, components of the second die 22 may be fabricated. The second profile panel 32′ may be manufactured using an additive manufacturing process as previously discussed while other components of the second die 22 may or may not be manufactured using an additive manufacturing process. Components of the second base 30′ may be assembled if they are not integrally formed. This may include positioning one or more ventilation tubes 48′ in the second cavity 38′ before securing the second profile panel 32′ to the second perimeter wall 42′.

Next, the second profile panel 32′ may be positioned on the second perimeter wall 42′ with the second seal 36′ sandwiched in between. For instance, the second seal 36′ may be installed on the second base 30′, such as by positioning the second seal 36′ in the second seal groove 50′, before installing the second profile panel 32′ (i.e., before positioning the second profile panel 32′ on the second perimeter wall 42′). Alternatively, the second seal 36′ may be installed on the second profile panel 32′, such as by providing the second seal 36′ on the back side of the rim 72′, before installing the second profile panel 32′ (i.e., before positioning the second profile panel 32′ on the second perimeter wall 42′). The second mounting panel 34′ may engage with the second profile panel 32′, the second perimeter wall 42′, or both. For example, the second mounting panel 34′ may be positioned to contact or engage the rim 72′ of the second profile panel 32′ and the second ring wall 52′ of the second perimeter wall 42′.

Next, the second profile panel 32′ may be secured to the second perimeter wall 42′ after positioning the second profile panel 32′ on the second perimeter wall 42′. Securing the second profile panel 32′ may include securing or fastening the second profile panel 32′ with one or more fasteners such as screws as previously discussed. In addition, the second profile panel 32′ may be fastened to a ventilation tube 48′.

The forming tool 10 may mold, cast, or otherwise shape material into a part when the first die 20 and the second die 22 are in the closed position. The material that is shaped into the part may be provided to the forming cavity 24 when the first die 20 and the second die 22 are in either the open position or the closed position. For example, the material may be poured onto a profile panel, such as the first profile panel 32, shortly before closing the forming tool 10. This technique may be best suited for a material that expands to fill the forming cavity 24 during forming, such as a foaming material. Alternatively, it is contemplated that the material may be injected into the forming cavity 24 when the forming tool 10 is closed.

Referring primarily to FIG. 6, the first profile panel 32 and the second profile panel 32′ may cooperate to define the forming cavity 24 when the forming tool 10 is in the closed position. In addition, the first mounting panel 34 may engage or contact the second mounting panel 34′ in the closed position.

The forming tool configuration in FIGS. 1-6 may allow a die to be reconfigured to make a differently configured part by replacing a profile panel (and optionally components in the cavity of the die such as baffles, support columns, ventilation tubes, or combinations thereof) while reusing other die components, which may reduce the tooling cost and tool manufacturing lead time as compared to providing individual dies that are configured to make a single part configuration. Reusing die components such as components of the base, seal, and mounting panel may also help improve the repeatability of the tool set up, which may help maintain or improve part quality. Manufacturing a profile panel with an additive manufacturing process may allow the profile panel to be efficiently made and may allow the profile panel to be made of a material that differs from other die components and that may be better suited for forming surfaces of the part, which may help improve tool durability and may help reduce scrap.

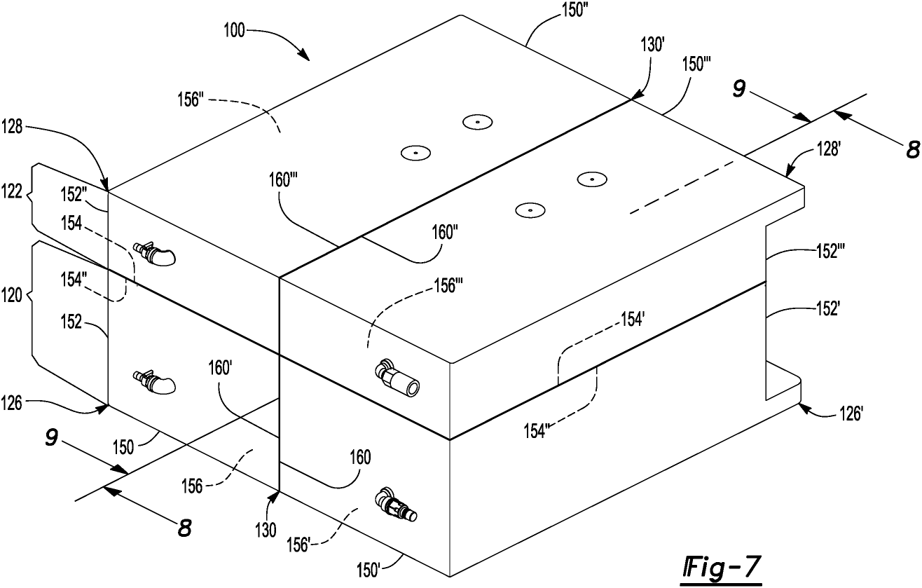

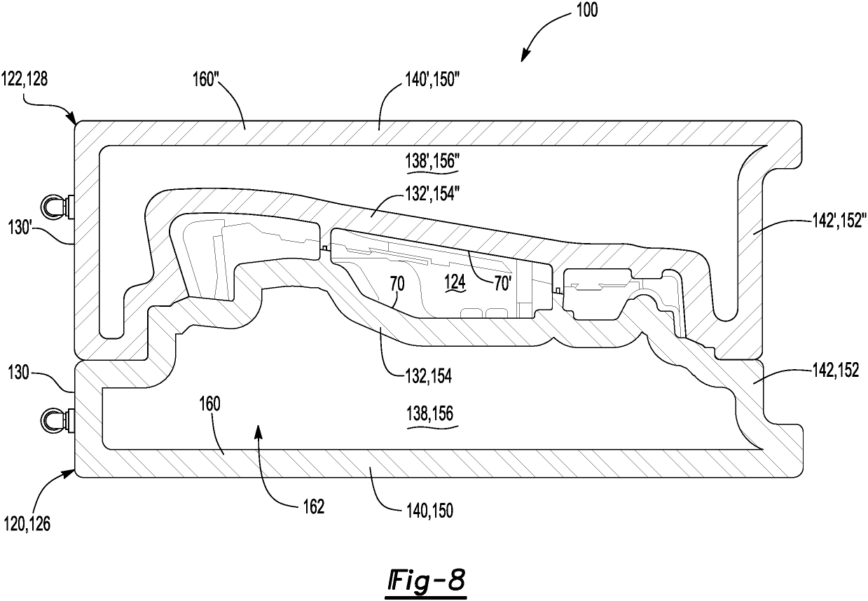

Referring to FIGS. 7 and 8, another configuration of a forming tool 100 is shown. In this configuration, the first die 120 and the second die 122 may be manufactured using an additive manufacturing process. In such a configuration, the first die 120 and the second die 122 may each include a plurality of die portions. Each die portion of a die may be manufactured using an additive manufacturing process. The die portions may be manufactured as separate parts. Then, the die portions may be assembled to each other to create a corresponding die. In the configuration shown, the first die 120 and the second die 122 are illustrated as each including two die portions; however, it is contemplated that different number of die portions may be provided. The die portions may cooperate to define a base and a profile panel of the die when assembled. Features or components that are additively manufactured may have a unitary or one-piece configuration. Using an additive manufacturing process to manufacture the die portions allows components such as a mounting panel and a seal may be omitted.

As an overview of FIG. 7, the first die 120 is depicted as being positioned below the second die 122 as represented by the generally horizontal parting line that separates the first die 120 from the second die. The first die 120 is divided into two die portions as represented by the vertical line that separates the first die 120 into left and right halves. This vertical line also represents where the two die portions of the first die 120 meet. The second die 122 is divided into two die portions as represented by the vertical line and rearward extending line that separate the second die 122 into left and right halves. This vertical line and rearward extending line represent where the two die portions of the second die 122 meet.

Referring to FIG. 7, the first die 120 may include a first die portion 126 and a second die portion 126′. The first die portion 126 and the second die portion 126′ may cooperate to define a first base 130 and a first profile panel 132, which is best shown in FIG. 8.

The first base 130 may be analogous to the first base 30 previously discussed. The first base 130 may support and may be integrally formed with the first profile panel 132. In at least one configuration, the first base 130 may include a first baseplate 140, a first perimeter wall 142, and one or more locator features. Optionally, the first base 130 may include one or more baffles, one or more support columns, or both.

The first base 130, and hence the first baseplate 140 and the first perimeter wall 142, may be partially defined by the first die portion 126. More specifically, the first die portion 126 of the first die 120 may define a first baseplate portion 150, a first perimeter wall portion 152, and a first profile panel portion 154. The first baseplate portion 150, the first perimeter wall portion 152, and the first profile panel portion 154 may cooperate to define a first cavity portion 156 in the first die portion 126.

The first baseplate portion 150 may be a portion or part of the first baseplate 140 that is defined by the first die portion 126. The first baseplate portion 150 may be a generally flat plate from which the first perimeter wall portion 152 may extend. The first baseplate portion 150 may be mountable to the press.

The first perimeter wall portion 152 may be a portion or part of the first perimeter wall 142 that is defined by the first die portion 126. The first perimeter wall portion 152 may extend from the first baseplate portion 150 to the first profile panel portion 154. The first perimeter wall portion 152 may include one or more walls that may define a portion of the perimeter of the first cavity 138.

The first profile panel 132 may be analogous to the first profile panel 32 previously discussed. As such, the first profile panel 132 may include a forming surface 70 that may be contoured or profiled to provide a desired shape to the material that is formed in the forming cavity 124, which is best shown in FIG. 8.

The first profile panel portion 154 may be a portion or part of the first profile panel 132 that is defined by the first die portion 126. The first profile panel portion 154 may extend from the first perimeter wall portion 152 and may be spaced apart from and disposed opposite the first baseplate portion 150. The first profile panel portion 154 may define a portion of the forming surface 70.

Referring primarily to FIG. 8, the first cavity portion 156 may be bounded by the first baseplate portion 150, the first perimeter wall portion 152, and the first profile panel portion 154. Referring to FIGS. 7 and 8, the first baseplate portion 150, the first perimeter wall portion 152, and first profile panel portion 154 may cooperate to define a first mating side 160 that may face toward and may engage the second die portion 126′ of the first die 120, which is best shown in FIG. 7. The first mating side 160 may define, surround, or encompass a first cavity portion opening 162, which is best shown in FIG. 8.

The first die portion 126 may be additively manufactured in a direction that extends toward the first mating side 160. For instance, the first die portion 126 may be additively manufactured beginning with the side of the first die portion 126 that is disposed opposite the first mating side 160, which may be the side position furthest to the left from the perspective shown in FIG. 7. The first die portion 126 may then be built up in a direction that extends toward the first mating side 160. Thus, the first die portion may be additively manufactured in an orientation that is rotated 90° counterclockwise from the orientation shown in FIG. 7.

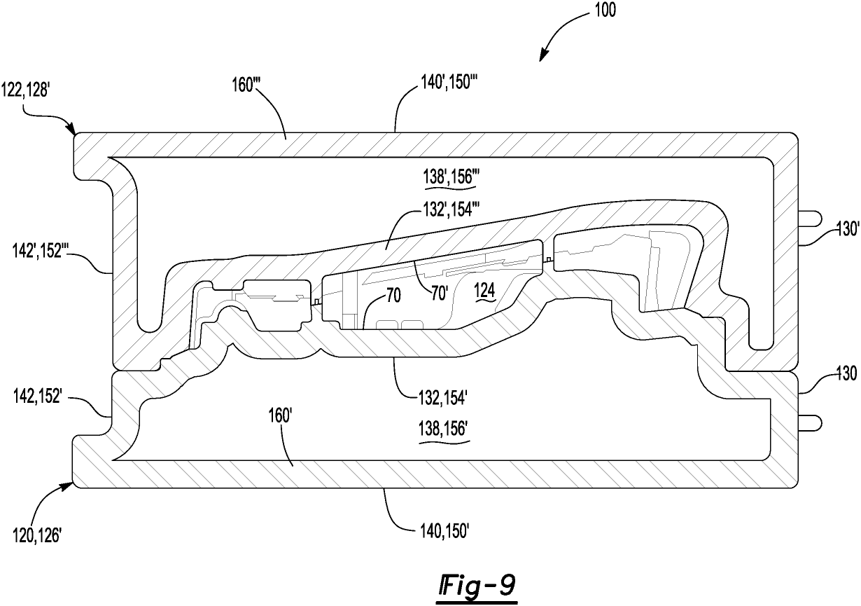

Referring to FIGS. 7 and 9, the second die portion 126′ may have a similar configuration as the first die portion 126. The first base 130, and hence the first baseplate 140 and the first perimeter wall 142, may be partially defined by the second die portion 126′. More specifically, the second die portion 126′ of the first die 120 may define a second baseplate portion 150′, and a second perimeter wall portion 152′, and a second profile panel portion 154′. The second baseplate portion 150′, the second perimeter wall portion 152′, and the second profile panel portion 154′ may cooperate to define a second cavity portion 156′ in the second die portion 126′.

The second baseplate portion 150′ may be a portion or part of the first baseplate 140 that is defined by the second die portion 126′. The second baseplate portion 150′ may be a generally flat plate from which the second perimeter wall portion 152′ may extend. The second baseplate portion 150′ may be mountable to the press.

The second perimeter wall portion 152′ may be a portion or part of the first perimeter wall 142 that is defined by the second die portion 126′. The second perimeter wall portion 152′ may extend from the second baseplate portion 150′ to the second profile panel portion 154′. The second perimeter wall portion 152′ may include one or more walls that may define a portion of the perimeter of the second cavity 138′.

The second profile panel portion 154′ may be a portion or part of the first profile panel 132 that is defined by the second die portion 126′. The second profile panel portion 154′ may extend from the second perimeter wall portion 152′ and may be spaced apart from and disposed opposite the second baseplate portion 150′. The second profile panel portion 154′ may define a portion of the forming surface 70.

The second cavity portion 156′ may be bounded by the second baseplate portion 150′, the second perimeter wall portion 152′, and the second profile panel portion 154′. The second baseplate portion 150′, the second perimeter wall portion 152′, and second profile panel portion 154′ may cooperate to define a second mating side 160′ that may face toward and may engage the first die portion 126 of the first die 120. The second mating side 160′ may define, surround, or encompass a second cavity portion opening.

The second die portion 126′ may be additively manufactured in a direction that extends toward the second mating side 160′. For instance, the second die portion 126′ may be additively and manufactured beginning with the side of the second die portion 126′ that is disposed opposite the second mating side 160′, which may be the side position furthest to the right from the perspective shown in FIG. 7. The second die portion 126′ may then be built up in a direction that extends toward the second mating side 160′.

The first die portion 126 and the second die portion 126′ of the first die 120 may be assembled to each other after the first die portion 126 and the second die portion 126′ are additively manufactured. For instance, the first die portion 126 and the second die portion 126′ may be oriented so that the first mating side 160 and the second mating side 160′ face toward each other and are aligned with each other. Then, the first die portion 126 and the second die portion 126′ may be attached or assembled to each other. The first die portion 126 and the second die portion 126′ may be assembled in any suitable manner, such as by bonding the first die portion 126 to the second die portion 126′ or bonding the first mating side 160 to the second mating side 160′. Bonding may be accomplished in any suitable manner, such as by using an adhesive or by welding. Once the first die portion is attached to the second die portion 126′, the first baseplate portion 150 extends from the second baseplate portion 150′, the first perimeter wall portion 152 extends from the second perimeter wall portion 152′, the first profile panel portion 154 extends from the second profile panel portion 154′, and the first cavity portion 156 extends from the second cavity portion 156′.

If desired, material may be removed from the forming surface 70 of the first profile panel 132 after the first die portion 126 and the second die portion 126′ are assembled to each other to provide a desired final forming surface geometry. For instance, material may be removed proximate the first mating side 160 and the second mating side 160′ to accommodate manufacturing tolerances or potential contour misalignment between the first profile panel portion 154 and the second profile panel portion 154′ or to accommodate imperfections that may have been introduced when the first die portion 126 and the second die portion 126′ were assembled to each other, such as excess adhesive.

Referring to FIG. 7, the second die 122 may be manufactured in a similar manner as the first die 120. For instance the second die 122 may have a first die portion 128 and a second die portion 128′. The first die portion 128 and the second die portion 128′ may cooperate to define a second base 130′ and a second profile panel 132′, which is best shown in FIG. 8.

The second base 130′ may be analogous to the second base 30′ previously discussed. The second base 130′ may support and may be integrally formed with the second profile panel 132′, which is best shown in FIG. 8. In at least one configuration, the second base 130′ may include a second baseplate 140′, a second perimeter wall 142′, and one or more locator features. Optionally, the second base 130′ may include one or more baffles, one or more ventilation tubes, or both.

The second base 130′, and hence the second baseplate 140′ and the second perimeter wall 142′, may be partially defined by the first die portion 128 and the second die portion 128′. The first die portion 128 may define a first baseplate portion 150″, a first perimeter wall portion 152″, and a first profile panel portion 154″, which is best shown in FIG. 8. The first baseplate portion 150″, the first perimeter wall portion 152″, and the first profile panel portion 154″ may cooperate to define a third cavity portion 156″. Referring primarily to FIGS. 7 and 9, the second die portion 128′ may define a second baseplate portion 150‴, and a second perimeter wall portion 152‴, and a second profile panel portion 154‴. The second baseplate portion 150‴, the second perimeter wall portion 152‴, and the second profile panel portion 154‴ may cooperate to define a fourth cavity portion 156‴.

Referring primarily to FIG. 8, the first baseplate portion 150″ may be a portion or part of the second baseplate 140′ that is defined by the first die portion 128. Referring primarily to FIG. 9, the second baseplate portion 150‴ may be a portion or part of the second baseplate 140′ that is defined by the second die portion 128′.

Referring primarily to FIG. 8, the first perimeter wall portion 152″ may be a portion or part of the second perimeter wall 142′ that is defined by the first die portion 128. The first perimeter wall portion 152″ may extend from the first baseplate portion 150″ to the first profile panel portion 154″. Referring primarily to FIG. 9, the second perimeter wall portion 152‴ may be a portion or part of the second perimeter wall 142′ that is defined by the second die portion 128′. The second perimeter wall portion 152‴ may extend from the second baseplate portion 150‴ to the second profile panel portion 154‴.

Referring to FIGS. 8 and 9, the second profile panel 132′ may be analogous to the second profile panel 32′ previously discussed. As such, the second profile panel 132′ may include a forming surface 70′ that may be contoured or profiled to provide a desired shape to the material that is formed in the forming cavity 24.

Referring primarily to FIG. 8, the first profile panel portion 154″ may be a portion or part of the first profile panel 132 that is defined by the first die portion 128. Referring primarily to FIG. 9, the second profile panel portion 154‴ may be portion or part of the second profile panel 132′ that is defined by the second die portion 128′. The first profile panel portion 154″ and the second profile panel portion 154‴ may cooperate to define the forming surface 70′.

Referring primarily to FIG. 8, the third cavity portion 156″ may be bounded by the first baseplate portion 150″, the first perimeter wall portion 152″, and the first profile panel portion 154″. The first baseplate portion 150″, the first perimeter wall portion 152″, and first profile panel portion 154″ may cooperate to define a first mating side 160″. Similarly, the fourth cavity portion 156‴, which is best shown in FIG. 9 may be bounded by the second baseplate portion 150‴, the second perimeter wall portion 152‴, and the second profile panel portion 154‴. The second baseplate portion 150‴, the second perimeter wall portion 152‴, and the second profile panel portion 154‴ may cooperate to define a second mating side 160‴. The first die portion 128 may be additively manufactured in a direction that extends toward the first mating side 160″. The second die portion 128′ may be additively manufactured in a direction that extends toward the second mating side 160‴.

The first die portion 128 and the second die portion 128′ of the second die 122 may be assembled to each other after the first die portion 128 and the second die portion 128′ are additively manufactured. For instance, the first die portion 128 and the second die portion 128′ may be oriented so that the first mating side 160″ and the second mating side 160‴ face toward each other and are aligned with each other. Then, the first die portion 128 and the second die portion 128′ may be attached or assembled to each other. The first die portion 128 and the second die portion 128′ may be assembled in any suitable manner, such as by bonding the first die portion 128 to the second die portion 128′ or bonding the first mating side 160″ to the second mating side 160‴. Once the first die portion 128 is attached to the second die portion 128′, the first baseplate portion 150″ extends from the second baseplate portion 150‴, the first perimeter wall portion 152″ extends from the second perimeter wall portion 152‴, the first profile panel portion 154″ extends from the second profile panel portion 154‴, and the third cavity portion 156″ extends from the fourth cavity portion 156‴. If desired, material may be removed from the forming surface 70′ of the second profile panel 132′ after the first die portion 128 and the second die portion 128′ are assembled to each other to provide a desired final forming surface geometry.

Components such as baffles and ventilation tubes may be installed inside a die portion before assembling the first die portion 128 and the second die portion 128′ to each other if provided as separate components. It is contemplated that a baffle may be additively manufactured rather than being provided as a separate component.

The forming tool configuration in FIGS. 7-9 may allow a die to be manufactured using an additive manufacturing process, which may reduce tooling cost and tool manufacturing lead time as compared to conventional dies. A die may be made of fewer individual components, which may help reduce assembly and alignment issues. In addition, a die may be sufficiently durable or usable to manufacture prototype and production parts as compared to having separate prototype and production dies, which may improve the correlation between prototyping production tooling.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of manufacturing a forming tool comprising:
making a first die by:
manufacturing a first profile panel with an additive manufacturing process;
providing a first base that has a first perimeter wall;
positioning the first profile panel on the first perimeter wall; and
securing the first profile panel to the first perimeter wall; making a second die by:
manufacturing a second profile panel with an additive manufacturing process;
providing a second base that has a second perimeter wall;
positioning the second profile panel on the second perimeter wall; and
securing the second profile panel to the second perimeter wall.

2. The method of claim 1 wherein the first base includes a first baseplate, the first perimeter wall extends from the first baseplate toward the first profile panel, and the first baseplate, the first perimeter wall, and the first profile panel cooperate to define a first cavity that receives a fluid.

3. The method of claim 2 wherein a baffle extends from the first baseplate to the first profile panel and has a first end that extends from the first perimeter wall and a second end that is spaced apart from the first perimeter wall, and the baffle directs the fluid around the second end.

4. The method of claim 2 wherein the first perimeter wall has a first locator feature that is disposed on a column that is disposed opposite the first cavity.

5. The method of claim 1 further comprising positioning a first seal between the first perimeter wall and the first profile panel before securing the first profile panel to the first perimeter wall.

6. The method of claim 5 wherein securing the first profile panel to the first perimeter wall includes positioning a first mounting panel into engagement with the first profile panel and the first perimeter wall such that the first profile panel extends from the first seal to the first mounting panel and fastening the first mounting panel to the first perimeter wall.

7. The method of claim 6 wherein the first perimeter wall defines a first seal groove that partially receives the first seal and a first ring wall that encircles the first seal groove and the first mounting panel, wherein the first profile panel is fastened to the first ring wall.

8. The method of claim 1 wherein the second base includes a second baseplate, the second perimeter wall extends from the second baseplate toward the second profile panel, and the second baseplate, the second perimeter wall, and the second profile panel cooperate to define a second cavity.

9. The method of claim 8 wherein the second perimeter wall has a second locator feature that is disposed on a column that is disposed opposite the second cavity.

10. The method of claim 8 further comprising positioning a ventilation tube in the second cavity before securing the second profile panel to the second perimeter wall, wherein the ventilation tube extends between a vent hole in the second profile panel and an exhaust hole in the second baseplate.

11. The method of claim 8 further comprising positioning a second seal between the second perimeter wall and the second profile panel before securing the second profile panel to the second perimeter wall.

12. The method of claim 11 wherein securing the second profile panel to the second perimeter wall includes positioning a second mounting panel into engagement with the second profile panel and the second perimeter wall such that the second profile panel extends from the second seal to the second mounting panel and fastening the second mounting panel to the second perimeter wall.

13. The method of claim 12 wherein the second perimeter wall defines a second seal groove that partially receives the second seal and a second ring wall that encircles the second seal groove and the second mounting panel, wherein the second profile panel is fastened to the second ring wall.

14. The method of claim 12 wherein a first mounting panel secures the first profile panel to the first perimeter wall and the method further includes aligning the first die and the second die and positioning the first mounting panel into engagement with the second mounting panel.

15. A method of manufacturing a forming tool comprising:
making a first die by:
manufacturing a first die portion of the first die with an additive manufacturing process, wherein the first die portion of the first die defines a first profile panel portion of a first profile panel, a first baseplate portion of a first baseplate, and a first perimeter wall portion of a first perimeter wall, and the first profile panel portion of the first profile panel, the first baseplate portion of the first baseplate, and the first perimeter wall portion of the first perimeter wall cooperate to define a first cavity portion;
manufacturing a second die portion of the first die with an additive manufacturing process, wherein the second die portion of the first die defines a second profile panel portion of the first profile panel, a second baseplate portion of the first baseplate, and a second perimeter wall portion of the first perimeter wall, and the second profile panel portion of the first profile panel, the second baseplate portion of the first baseplate, and the second perimeter wall portion of the first perimeter wall cooperate to define a second cavity portion; and
assembling the first die portion of the first die to the second die portion of the first die such that the first profile panel portion extends from the second profile panel portion, the first baseplate portion extends from the second baseplate portion, and the first perimeter wall portion extends from the second perimeter wall portion.

16. The method of claim 15 wherein assembling the first die portion of the first die to the second die portion of the first die includes bonding the first profile panel portion to the second profile panel portion, bonding the first baseplate portion to the second baseplate portion, and bonding the first perimeter wall portion to the second perimeter wall portion.

17. The method of claim 15 further comprising removing material from the first profile panel of the first die after assembling the first die portion of the first die to the second die portion of the first die.

18. The method of claim 15 further comprising making a second die by:
manufacturing a first die portion of the second die with an additive manufacturing process, wherein the first die portion of the second die defines a first profile panel portion of a second profile panel, a first baseplate portion of a second baseplate, and a first perimeter wall portion of a second perimeter wall, and the first profile panel portion of the second profile panel, the first baseplate portion of the second baseplate, and the first perimeter wall portion of the second perimeter wall cooperate to define a third cavity portion;
manufacturing a second die portion of the second die with an additive manufacturing process, wherein the second die portion of the second die defines a second profile panel portion of the second profile panel, a second baseplate portion of the second baseplate, and a second perimeter wall portion of the second perimeter wall, and the second profile panel portion of the second profile panel, the second baseplate portion of the second baseplate, and the second perimeter wall portion of the second perimeter wall cooperate to define a fourth cavity portion; and
assembling the first die portion of the second die to the second die portion of the second die such that the first profile panel portion of the second profile panel extends from the second profile panel portion of the second profile panel, the first baseplate portion of the second baseplate extends from the second baseplate portion of the second baseplate, and the first perimeter wall portion of the second perimeter wall extends from the second perimeter wall portion of the second perimeter wall.

19. The method of claim 18 wherein assembling the first die portion of the second die to the second die portion of the second die includes bonding the first profile panel portion of the second profile panel to the second profile panel portion of the second profile panel, bonding the first baseplate portion of the second baseplate to the second baseplate portion of the second baseplate, and bonding the first perimeter wall portion of the second perimeter wall to the second perimeter wall portion of the second perimeter wall.

20. The method of claim 18 further comprising removing material from the second profile panel of the second die after assembling the first die portion of the second die to the second die portion of the second die.
